(19) United States
(12) Patent Application Publication
(10) Pub. No.: US 2026/0251442 A1
(43) Pub. Date: Aug. 27, 2026

(54) DEFORMABLE SENSOR WITH A GRANULAR MEDIUM AND SYSTEMS AND METHODS FOR CONTROLLING THE SAME

(71) Applicant: Toyota Research Institute, Inc., Los Altos, CA (US)

(72) Inventors: Edwardo Martinez, Fremont, CA (US); Jonathan Yao, San Jose, CA (US)

(73) Assignees: Toyota Research Institute, Inc., Los Altos, CA (US); Toyota Jidosha Kabushiki Kaisha, Toyota-Shi Aichi-Ken (JP)

(21) Appl. No.: 19/060,107

(22) Filed: Feb. 21, 2025

(51) Int. Cl. G01B 11/24

(52) U.S. Cl. CPC G01B 11/24

(57) ABSTRACT

A deformable sensor and a system and method for operating the same are disclosed. The deformable sensor includes a deformable membrane and a granular medium contained with an enclosure at least partially delimited thereby. The granular medium may be fluidized, thereby influencing and/or adjusting the malleability and/or tactile response of the deformable sensor for a variety of applications. Deformations in the deformable membrane may then be observed by one or more sensors to ascertain geometries and/or poses of objects gripped and or otherwise pressed against the deformable sensor. The system may include a controller for operating the deformable sensor as well as a pressurized fluid source for supplying a working fluid. The method includes providing such a deformable sensor, fluidizing the granular medium, and bringing the deformable sensor into contact with an object to be measured or gripped.

### TECHNICAL FIELD

Embodiments described herein generally relate to deformable sensors and, more particularly, to deformable sensors, which utilize a granular medium and concepts relating to liquefaction, in part, to change the malleability of the sensor.

### BACKGROUND

Deformable sensors are sensors that comprise a deformable membrane that define an enclosure that may be filled with a medium. An internal sensor is disposed within the enclosure and has a field of view of a bottom surface of the deformable membrane. The internal sensor can detect when an object is pressed against the deformable membrane and such that the deformable membrane deforms toward the internal sensor.

Typically, the enclosure may be filled with air or some other working gas and pressurized such that the deformable membrane forms a dome or similar shape. The pressure within the deformable sensor controls how hard or easy it is to deform the deformable membrane when the deformable membrane is brought into contact with an object. A higher pressure inside the enclosure typically correlates with a harder sensor, whereas a lower pressure inside the enclosure correlates with a softer sensor.

Alternative deformable sensor configurations, systems, and methods are desired to expand the operating regime of the deformable sensor.

### SUMMARY

In one embodiment, a deformable sensor includes deformable membrane and housing which delimit an enclosure, in which is contained a granular medium. The granular medium may be fluidized by an agitator, such as a working fluid source, aerator, and/or vibrator, to thereby influence the malleability and/or tactile response of the deformable sensor.

In another embodiment, a system which includes a deformable sensor and a controller for operating the same, which may include a working fluid source and/or pressurization means for providing a working fluid to the deformable sensor.

In another embodiment, a method for operating a deformable sensor which includes providing a deformable sensor, fluidizing a granular medium contained therein, and bringing the deformable sensor into contact with an object to ascertain parameters such as a geometry and/or a pose of the object.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a cross-sectional view of a deformable sensor according to one or more embodiments described and illustrated herein;

FIG. 2 schematically depicts a cross-sectional view of a deformable sensor according to one or more embodiments described and illustrated herein;

FIG. 3A schematically depicts an exemplary configuration of a granular medium according to one or more embodiments described and illustrated herein;

FIG. 3B schematically depicts another exemplary configuration of a granular medium according to one or more embodiments described and illustrated herein;

FIG. 4A schematically depicts an exemplary configuration of a flexible membrane according to one or more embodiments described and/or illustrated herein;

FIG. 4B schematically depicts another exemplary configuration of a flexible membrane according to one or more embodiments described and/or illustrated herein;

FIG. 4C schematically depicts another exemplary configuration of a flexible membrane according to one or more embodiments described and/or illustrated herein;

FIG. 4D schematically depicts another exemplary configuration of a flexible membrane according to one or more embodiments described and illustrated herein;

FIG. 5A schematically depicts an exemplary shape and configuration of a flexible membrane according to one or more embodiments described and illustrated herein;

FIG. 5B schematically depicts another exemplary shape and configuration of a flexible membrane according to one or more embodiments described and illustrated herein;

FIG. 5C schematically depicts another exemplary shape and configuration of a flexible membrane according to one or more embodiments described and illustrated herein;

FIG. 5D schematically depicts another exemplary shape and configuration of a flexible membrane according to one or more embodiments described and illustrated herein;

FIG. 6A schematically depicts a cross-sectional view of a deformable sensor according to one or more embodiments described and illustrated herein;

FIG. 6B schematically depicts a cross-sectional view of two deformable sensors according to one or more embodiments described and illustrated herein;

FIG. 7 is a block diagram depicting a system that includes a deformable sensor according to one or more embodiments described and illustrated herein;

FIG. 8 depicts an exemplary flow chart relating to the operation of a deformable sensor according to one or more embodiments described and illustrated herein.

### DETAILED DESCRIPTION

As humans, our sense of touch allows us to determine the shape of an object without looking at the object. Further, our sense of touch provides information as to how to properly grasp and hold an object. Our fingers are more sensitive to touch than other parts of the body, such as arms. This is because we manipulate objects with our hands.

Robots are commonly equipped with end effectors that are configured to perform certain tasks. For example, an end effector of a robotic arm may be configured as a human hand, or as a two-fingered gripper. However, robots do not have varying levels of touch sensitivity as do humans. End effectors may include sensors such as pressure sensors, but such sensors provide limited information about the object that is in contact with the end effector. Thus, the robot may damage a target object by using too much force, or drop the object because it does not properly grasp the object.

Further, in some applications, a deformable/compliant end effector may be desirable. For example, a deformable end effector may be desirable in robot-human interactions. Further, a deformable/compliant end effector may be desirable when the robot manipulates fragile objects. However, due to material limits of the membrane and/or the housing which form the enclosure, it may become difficult to reasonably achieve the necessary malleability for certain use cases while maintaining functionality of the sensor.

Embodiments of the present disclosure are therefore directed to deformable/compliant contact and/or geometry sensors (hereinafter “deformable sensors”) that may be configured to detect contact with a target object and/or detect the geometry, pose, and contact force of the target object. In some embodiments, the deformable sensors may include a deformable membrane coupled to a housing that includes a sensor capable of detecting displacement of the deformable membrane by contact with an object. In some embodiments, the deformable sensors may be filled with a granular medium, such as sand or glass beads, that may be fluidized by the dispersal of a working fluid through the granular medium, thereby facilitating finer control over the malleability and/or other “touch” characteristics of the deformable sensor. In some embodiments, the deformable membrane may be permeable so as to allow the working fluid to exit an enclosure of the deformable sensor and/or to further facilitate finer control over the malleability and/or other touch characteristics of the deformable sensor. In some embodiments, the granular medium may be fluidized by the application of a vibrational or thermal stimulus to achieve similar effect. As a result, those configurations of deformable sensors described herein may be configured to detect the pressure or force that is applied to the deformable membrane. Thus, the deformable sensors described herein may provide a robot (or other device) with a pseudo sense of touch when manipulating objects.

Additionally, the deformable sensors described herein may provide technical advantages over other sensor configurations in that the use of a fluidized, granular medium as the primary reactionary “force” of the sensor unlocks numerous parameters that may be adjusted to achieve a specific touch behavior of the sensor and, in some cases, completely new touch behaviors. Exemplary adjustable parameters may include qualities such as grain size of the granular medium, grain density, grain shape and/or roughness, grain homogeneity, fill percentage/ullage percentage, the type of working fluid used, the pressure and/or flow rate of the working fluid, whether and/or how and/or in what patterns air is permitted to pass through or permeate the deformable membrane, and the like. By adjusting these parameters, the malleability of the sensor can be increased and/or decreased, the touching force and/or force distribution may be influenced, specific touch patterns and/or gripping patterns may be generated, and more. Use of a fluidized, granular medium also may obviate the need to keep the body of the sensor air-tight, thereby making the sensor more puncture resistant and/or easier to manufacture.

Embodiments of the disclosure herein therefore endeavor to provide for an improved deformable sensor that may enable different sensing and manipulation interactions and have a wider operative range, improved durability, and/or different failure modes.

As will be discussed in more detail herein, these benefits are achieved by leveraging the concept of liquefaction, which is a process through which a solid material is caused to exhibit the properties of a fluid. While the most well-known instance of liquefaction is melting in response to a thermal stimulus, liquefaction may also be achieved by applying a mechanical stimulus to a granular solid medium, such that a bulk granular medium turns into a liquid-like state. This is achieved without the individual granules undergoing a phase change. For example, mechanical stimuli may include, but are not limited to, vibratory inputs and/or fluid injection, such as a flow of a gas and/or liquid.

For the purposes of the disclosures herein, a fluid is understood to be a liquid, gas, gel, and/or any other material that may continuously move and/or deform in response to applied shear stresses or forces. Similarly, for the purposes of the disclosures herein, the term “fluidize” is understood to mean “to cause to behave like a fluid,” consistent with the concepts outlined herein.

As an illustrative example, pressing with one’s hand upon the surface of a container of sand which is otherwise undisturbed will result in the sand resisting that force and behaving like a semi-solid surface, akin to walking on a sandy beach. However, by injecting or bubbling a fluid, such as air or water, through that container of sand, the sand will undergo liquefaction and be fluidized. As a result, pressing with one’s hand upon the surface of a container of fluidized sand will be met with significantly less resistance, almost as if one were pressing their hand into a container of water. This effect will continue until the fluid input is terminated, at which point the sand returns to its original state. Comparable effects may also be achieved with suitable vibratory inputs.

The use of mechanical stimuli is beneficial in that extreme temperatures may be avoided when fluidizing the solid or solid granular medium, thereby expanding the selection of viable mediums for a given application and/or the range of applications.

Additionally, mechanical stimuli tend to have a faster response time and broader control regime than thermal stimuli, and therefore permit a greater flexibility in choosing or otherwise “dialing in” the mechanical properties of the fluidized medium and/or provide a greater control response time. For example, increasing the intensity of the mechanical stimulus can controllably reduce the viscosity of the fluidized granular medium, thereby leading to a “softer” deformable sensor. Likewise, reducing the intensity of the mechanical stimulus can controllably increase the viscosity of the fluidized granular medium, thereby leading to a “harder” deformable sensor. Increasing or decreasing the intensity of the mechanical stimulus may be achieved by manipulating control factors such as the amplitude and/or frequency of a vibratory input, the pressure and/or flow rate of a fluid input or fluid injection, and the like. It is also contemplated that amplitude/frequency modulation, duty cycle setting/modulation, and/or patterning of these control factors, in any combination, may be used to further set or select a desired behavior of the granular medium and, as a result, of the deformable sensor.

Nevertheless, while the following descriptions emphasize the use of granular mediums and/or the use mechanical stimuli to achieve liquefaction, it is also contemplated that the embodiments described herein may be operable with fully solid mediums, viscous mediums, and/or with comparable thermal stimuli. For example, Gallium, which has a melting point of approximately 86 degrees Fahrenheit (or approximately 30 degrees Celsius) may be easily melted or frozen at near-room temperatures, avoiding concerns regarding extreme operating temperatures.

Thermal stimuli may also take advantage of, for example, the relationship between viscosity and temperature of a substance in controlling the behavior of the medium. For example, warming a viscous medium may reduce its viscosity and thereby “soften” a touch response of the deformable sensor, while cooling said viscous medium may increase its viscosity and thereby “harden” a touch response of the deformable sensor.

The following will now describe embodiments of the systems and methods in more detail with reference to the drawings and where like numbers refer to like structures.

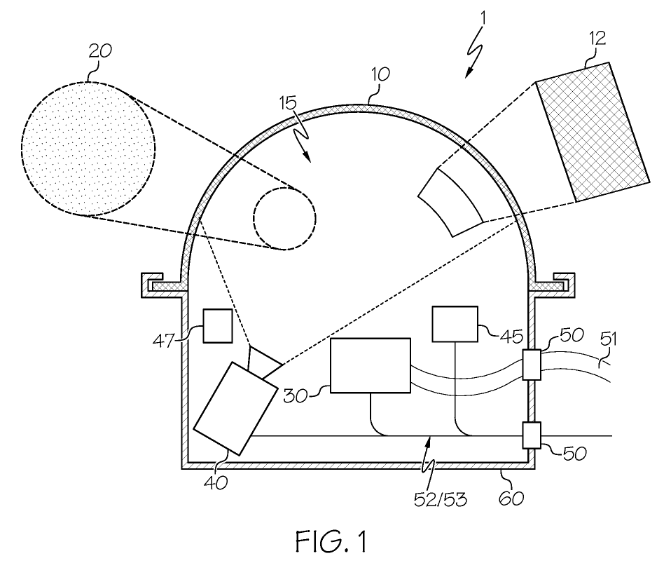

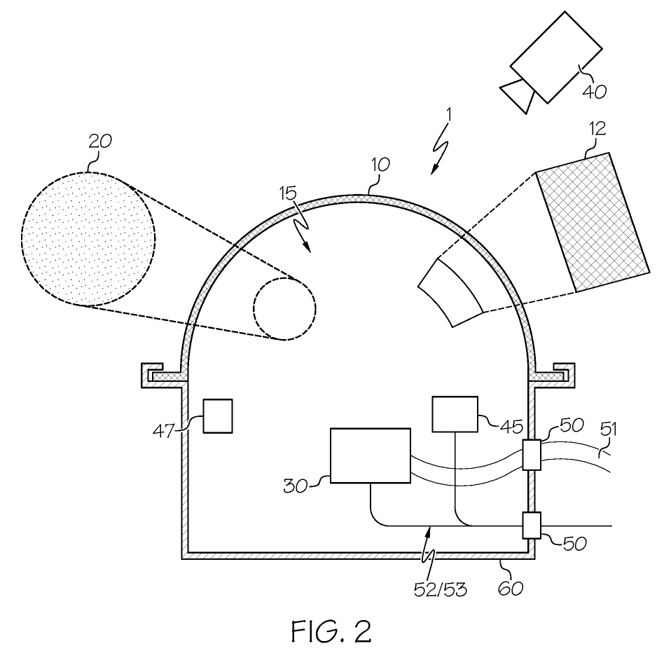

Referring now to FIGS. 1 and 2, exemplary embodiments of a deformable sensor 1 are illustrated. A deformable membrane 10 at least partially bounds an enclosure 15 in which a granular medium 20 is disposed. The enclosure 15 may optionally be further bounded by a housing 60, or solid body, to which the deformable membrane 10 is coupled, attached, bonded, or otherwise secured. One or more interfaces 50 may optionally be provided in either the housing 60 or deformable membrane 10 to facilitate the exchange of a working fluid, electrical power and/or signals, or the like into and/or out of the enclosure 15. Accordingly, it is contemplated that, in some embodiments, the enclosure 15 may be contained by only a deformable membrane 10 and without the need for a housing.

The one or more interfaces 50, for example, may include a plug (male or female), coupling, fitting, connector, quick-connector, grommet, eyelet, or the like for an air or fluid line 51, an electrical line 52, and/or a data or signal line 53. The one or more interfaces 50 may, alternatively, and in any combination, simply comprise a hole in the housing 60 or deformable membrane 10 through which an air or fluid hose or tube, power line, signal line, or the like may pass. In either case, the one or more interfaces 50 are configured to permit the requisite inputs/outputs to the deformable sensor 1 and may optionally be configured to minimize and/or eliminate leakages of the granular medium 20 and/or working fluid through the same. To this end, the one or more interfaces 50 may be self-sealing or may be used in conjunction with other elements, such as O-Rings, threading tape, or the like to achieve the desired degree of sealing.

The deformable sensor 1 may further include an agitator 30 or comparable device which is configured to fluidize the granular medium 20. The agitator 30 may be, for example, a fluid diffuser, an aerator 32, an aeration stone, a vibrator 34, or any combination of the same. The agitator 30 may be disposed inside or outside of the enclosure 15, may at least partially bound the enclosure, and/or may be formed as part of the housing 60. The agitator 30 may be connected to any combination of fluid lines 51, electrical lines 52, and/or signal lines 53 as required for operation.

In one embodiment, an agitator may be embodied as an aerator 32 and connected to a fluid line 51. In some embodiments, the aerator is disposed within the enclosure 15 and said fluid line 51 may pass through one or more interfaces 50. A working fluid, such as air, an inert gas, a reactive gas, oil, lubricant, water, or the like, without limitation, may be pumped through the aerator 32 and into the enclosure 15. The aerator 32 may be a porous, spongy, or otherwise open-celled material, such as an aeration stone or metal foam, which expels the working fluid and/or any other inputs through pores provided on the surface of the aerator 32, thereby diffusing and/or “bubbling” the working fluid over an area. In this way, the diffused working fluid may pass, flow, or otherwise bubble through the granular medium 20, thereby fluidizing the granular medium 20. The aerator 32, as used herein, may also refer to a fluid diffuser, such that the aerator 32 may be operable with liquid or gas working fluids.

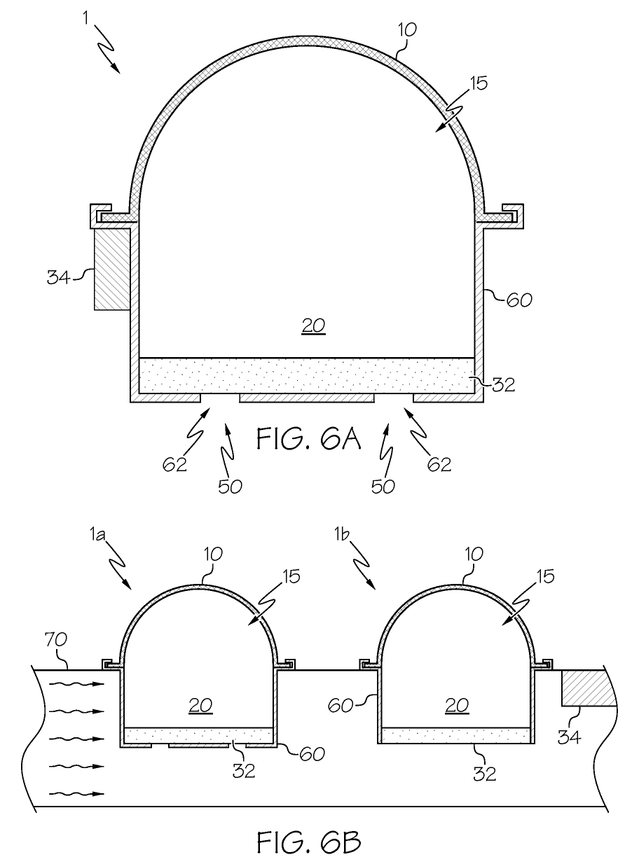

In some embodiments, an agitator 30 embodied at least as an aerator 32 may form part of a wall of the housing 60, as shown in FIGS. 6A-B. In this way, the deformable sensor 1, either by the housing 60 or otherwise, may be secured to a plenum 70 or the like which provides the fluid input to the deformable sensor 1.

In another embodiment, the granular medium 20 itself, or a subpart thereof, may serve as a suitable diffuser/aerator.

In another embodiment, an agitator 30 embodied as a vibrator 34 may be disposed inside or outside of the enclosure 15, may at least partially bound the enclosure, may be provided in, on, and/or as part of a wall of the housing 60, and/or may be provided on a supporting means, plenum, or other device on/in which the deformable sensor 1, either via the housing 60 or otherwise, is arranged. The vibrator 34 is therefore arranged and/or configured in a manner such that vibrations caused or emitted by the vibrator 34 may be, directly or indirectly, transmitted to the granular medium 20 within the enclosure 15. In this way, the vibrations may fluidize or aid in fluidizing the granular medium 20. The vibrator 34 may be electrically driven and/or pneumatically driven. In some embodiments, the working fluid may serve to operate the vibrator, as the case may be with tools that operate using compressed air or the like. In some embodiments, pulsing of a flow of the working fluid may be used to generate a vibrational effect.

In another embodiment, the agitator 30 may be a heating element, such as a resistive heater, and/or heat exchanger that may fluidize the granular medium 20 and/or subparts thereof by melting and/or that may reduce the viscosity of the granular medium 20 and/or subparts thereof by heating.

Also shown in FIGS. 1-2 are one or more sensors 40 configured to observe the deformable membrane 10. The one or more sensors 40 may be configured to detect and/or otherwise generate one or more signals indicating deformations to the deformable membrane 10, such as when an object is contacts the deformable membrane 10. The one or more sensors 40 may be disposed inside the enclosure 15 observing an inner surface of the deformable membrane 10, outside of the enclosure 15 and observing an outer surface of the deformable membrane 10, or both. The one or more sensors 40 may be one or more cameras, but are not limited only to visual light sensing means. The one or more sensors 40 may include infrared sensors, radar sensors, microwave sensors, ultraviolet sensors, sound and/or sonar sensors, ultrasound sensors, time of flight sensors, stereoscopic sensors, and the like, without limitation. The one or more sensors 40 may operate to generate point maps, depth maps, image maps, or any other data structure suitable to detect deformation of the deformable membrane 10 and/or the geometry of any such deformation to a desired level of accuracy.

For example, it may be desirable to simply detect if a deformation of the deformable membrane 10 occurs, which may be achieved using a low-resolution camera. In another example, it may be desirable to resolve details of the deformation to a sufficient degree from which features of the object contacting the deformable membrane 10 might be identified so that further computational efforts might derive what part of the object is being gripped by the deformable sensor 1.

The deformable sensor 1 may also include an emitter 47, or light, to assist with any of the one or more sensors 40. As with the one or more sensors 40, the emitter 47 may be placed anywhere inside or outside of the enclosure. The emitter 47 may also be part of the one or more sensors 40 or any other part of the deformable sensor 1, such as the agitator 30, vibrator 34, aerator 32, housing 16, or the like, which may facilitate a more compact design and/or may reduce the number of interfaces 50 needed. As above with the one or more sensors 40, the emitter 47 is not limited to visible light, but may serve as an emitter of energy corresponding to the sensitivity spectrum of the one or more sensors 40.

Additionally or alternatively, a microphone 45, such as a contact microphone, may be disposed on the housing 60, as part of the housing 60, or within the enclosure 15. The microphone 45 may be used to detect whether and/or when the deformable membrane 10 of the deformable sensor 1 is brought into contact with an object. In some embodiments, detecting such contact may serve to activate the deformable sensor 1 and any of the one or more sensors 40 if the deformable sensor 1 is not already active or in a hibernating/suspended/power-saving state.

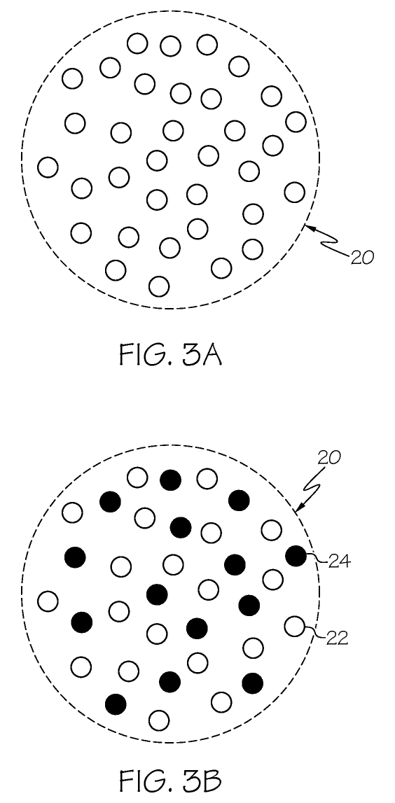

Referring now to FIGS. 3A-3B, the granular medium 20 may include materials such as sands, glass beads, abrasives, ball bearings, marbles, powders, fine particulates, gel beads (e.g., water beads, hydrogel beads, polymer beads, superabsorbent polymer beads), plastic grains, metal grains, and the like and/or combinations thereof. The grains/particles constituting the granular medium 20 may be uniformly formed/shaped, inconsistently and/or irregularly formed/ shaped, or some combination thereof.

The granular medium 20 may be homogeneous, as shown in FIG. 3A. The granular medium may be a mixture of differing materials, such as the mixture of transparent grains 22 and opaque grains 24 shown in FIG. 3B, and/or a mixture of different sizes of one or materials (e.g, a mixture of glass beads having different screen sizes, diameters, or grits). The mixture may be evenly dispersed and/or mixed throughout the enclosure, or there may be some bias or structure with respect to how the mixture is dispersed/mixed. For example, the granular medium 20 may comprise mostly transparent grains 22 throughout the enclosure 15 and some opaque grains 24 only near the deformable membrane 10.

It should be noted that, for the purposes of the disclosure herein, transparency is determined relative to the sensing mode of the one or more sensors 40. For example, if the one or more sensors 40 are infrared sensors, materials which are known to be transparent with respect to infrared light but opaque with respect to visible light may be utilized. In other words, in those embodiments which include a mixture of transparent grains 22 and opaque grains 24, this means that the one or more sensors 40 can detect or “see” the opaque grains 24 and do not detect or may ignore or “see through” the transparent grains 22, irrespective of how these grains might appear to the human eye.

The size of the grains comprising the granular medium 20 may be application dependent. For example, if gripping a small object or gripping an object where it is desirable to resolve fine details, small grains such as sand or abrasives may be utilized. Small grains may have a nominal diameter or average diameter of approximately 40 microns, 50 microns, 60 microns, 100 microns, and/or 250 microns, or may fall within a range of about 60 microns to about 2000 microns. In another example, if gripping a larger object or gripping an object where only coarse details may be discerned, larger grain sizes such as gravel, marbles, and the like, having a nominal diameter of greater than 2 millimeters, greater than 4 millimeters, or in a range of 2 millimeters to 75 millimeters, may be used. Furthermore, the size of the grains may be limited based on the size of any perforations provided in the deformable membrane 10, to ensure that the deformable membrane 10 is still able to retain the grains within the housing. It may be appreciated that these are simply examples, not limitations, as embodiments may utilize a small grain size when gripping a large object, or a large grain size when gripping a small object. Grain sizes smaller than or larger than those listed above may also be used. Furthermore, it may be appreciated that a given grain “size” may encompass a mixture of grain sizes that fall within a set range, such as the standard “screen size” used when categorizing abrasives. It should be noted that the use of the term “grains” herein to describe constituent elements of the granular medium 20 is not intended to be limiting with respect to the size of these constituent parts, and thus “grains” may include pellets, beads, nuggets, particles, dust, powder, flecks, and the like, without limitation.

It is therefore contemplated that different grain sizes, types, and mixtures may be utilized independently or in combination to achieve different characteristics of a deformable membrane when the granular medium 20 is fluidized or in a static state.

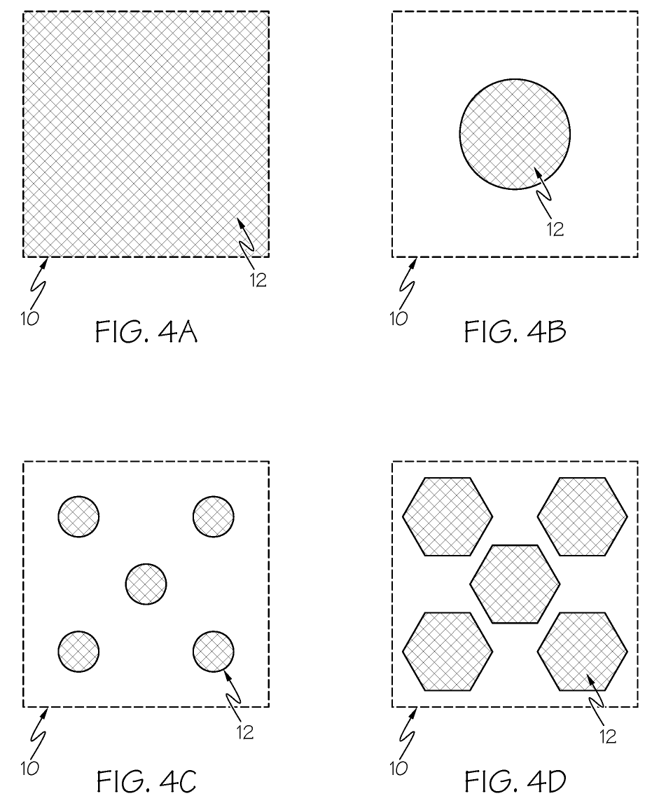

Referring now to FIGS. 4A-D, the deformable membrane 10 may be formed from a pliable material, such as silicon, nylon, polyester, rubber, latex, or the like. The deformable membrane 10 may be a mesh or other permeable material that may be constructed in a woven, layered, or other construction process. The extent to which the deformable membrane 10 is pliable may be influenced by adjusting the thickness of the deformable membrane 10 and/or patterning the thickness of the deformable membrane 10 to achieve any desired characteristics.

The deformable membrane 10 may be impermeable with respect to the granular medium 20 and any working fluids, or the deformable membrane 10 may be provided with perforations 12 – such as holes, gaps, voids between strands of a mesh or weave, or the like – through which one or both of the granular medium 20 and any working fluids may pass. In some embodiments, the perforations 12 and/or grains of the granular medium 20 may be sized to permit the working fluid to pass through the deformable membrane 10 but to prevent the granular medium 20 from passing through the deformable membrane 10, so that the granular medium 20 remains largely contained within the enclosure 15. For example, the perforations 12 may have a diameter or an effective diameter of 40 microns while the granular medium 20 comprises grains with nominal diameters of greater than 40 microns.

As shown in FIG. 4A, the perforations 12 may cover the entire surface of the deformable membrane 10. As shown in FIG. 4B, the perforations 12 may only cover a part of the surface of the deformable membrane 10. As shown in FIGS. 4C-4D, the perforations 12 may cover parts of the surface of the deformable membrane to form some kind of pattern or design. This pattern or design may be regular or irregularly shaped and may be decorative and/or functional. Patterning the deformable membrane 10 in this way may aid in specifying the pliability of the deformable membrane, such that areas with perforations 12 may be more pliable than those without. Patterning the deformable membrane 10 may also influence the fluidization characteristics of the granular medium 20 by restricting where said working fluid may pass through the deformable membrane.

It is also contemplated that the deformable membrane 10 may be patterned, such as with a grid or other pattern visible to the sensor 40, in a manner that assists the one or more sensors 40 in identifying deformations of the deformable membrane 10 when the deformable membrane 10 is brought into contact with an object.

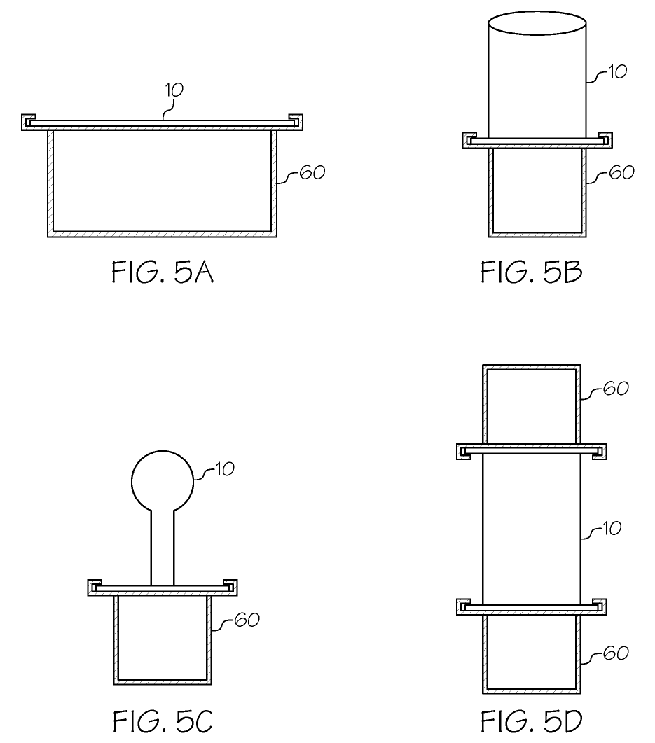

In those embodiments depicted in FIGS. 1-2, the deformable membrane 10 is shown having a dome shape. However, as exemplified through FIGS. 5A-5D, the deformable membrane 10 may have any shape. For example, FIG. 5A depicts the deformable membrane 10 formed to be substantially flat across the top of the housing 60. As another example, FIG. 5B depicts the deformable membrane 10 formed to have a cylindrical shape. As another example, FIG. 5C shows the deformable membrane 10 formed to have an elongated shape, with or without a bulb at the end, to facilitate evaluation and/or manipulation within internal geometries. As another example, FIG. 5D shows the deformable membrane stretched between two housings 60 to form a tube or planar shape. In other words, the deformable membrane 10 is not limited to only those shapes which are cantilevered from a single housing 60.

Referring now to FIG. 6A, an embodiment of the deformable sensor 1 including both a vibrator 34 disposed outside of the housing 60 and an aerator 32 disposed at the bottom of the housing 60 is shown. However, other embodiments in which the vibrator 34 is in or part of the aerator, such that the two together form a single agitator 30, are also contemplated. Additionally, here, the one or more interfaces 50 provided in the housing are may be holes 62 in the bottom of the housing 60, such that the aerator 32 prevents the granular medium 20 from leaving the enclosure 15 through the one or more interfaces 50.

Referring now to FIG. 6B, an embodiment including more than one deformable sensor 1 is shown. The deformable sensors 1a, 1b are each in turn secured to a plenum 70 which, instead of a hose or tube, may serve as the source for the working fluid that may be injected into the deformable sensor 1. Additionally, a vibrator 34 secured to the plenum may thereby transmit vibrations through the walls of the plenum 70 to any deformable sensors 1 also attached to the plenum, instead of or in addition to any vibrator(s) 34 placed on/in the deformable sensors 1. In this way, a single vibrator 34 may serve to operate multiple deformable sensors 1. Also shown in FIG. 6B is the configuration of a deformable sensor 1a shown in FIG. 6A, whereby the aerator 32 rests on the bottom wall of the housing 60 and the interfaces 50 are formed as holes 62 in a wall of the housing 60. FIG. 6B also shows another embodiment of the deformable sensor 1b in which the aerator 32 at least partially bounds the enclosure 15.

Accordingly, it is contemplated that the deformable sensors 1 may be employed singly or as part of an array of deformable sensors 1.

It may also be appreciated that the sensors 40, emitters 47, microphones 45, interfaces 50, lines 51/52/53, and the like have been omitted from FIGS. 5A-6B for ease of illustration only, and that each of the configurations shown in FIGS. 5A-6B may be instrumented in a similar manner as those depicted in FIGS. 1-2.

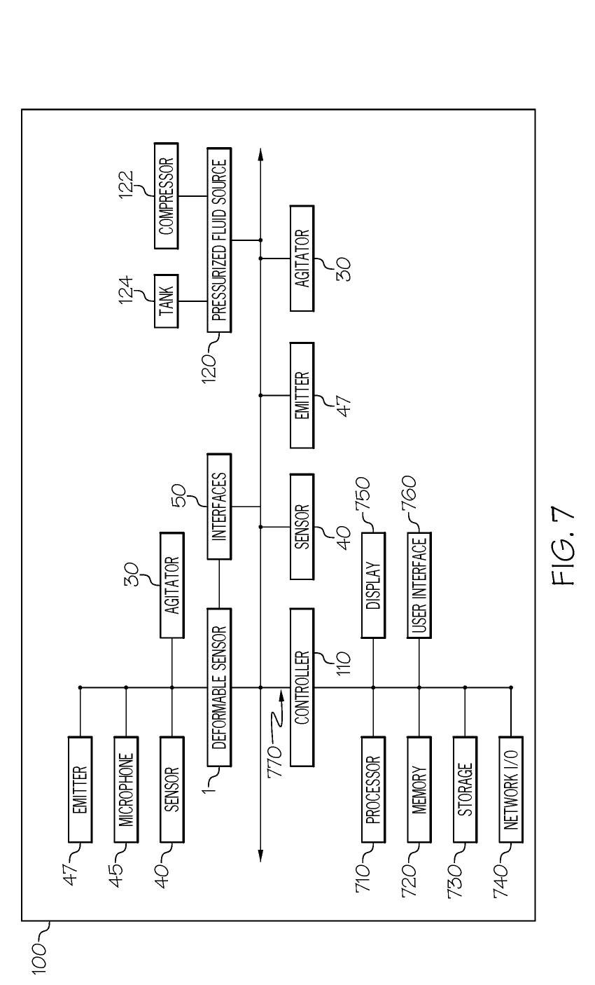

Referring now to FIG. 7, a system 100 for operating a deformable sensor 1 according to any of the embodiments disclosed herein is shown. The system 100 may include one or more deformable sensors 1 and a controller 110.

The controller 110 may include one or more computing devices, each having one or more: processors 710, memory units 720, storage units 730, displays 750, user interfaces (physical or otherwise) 760, network interfaces 740, and the like. The one or more computing devices and constituent parts may be communicatively coupled together to operate the system 100 and any deformable sensors 1 connected thereto. The one or more processors 710 may include central processing units (CPUs) or other general purpose processors and/or microcontrollers, application-specific integrated circuits (ASICs), field-programmable gate arrays (FPGAs), and the like in any combination. The one or more storage units 730 and/or memory units 720 may contain computer code containing instructions that, when executed by the one or more processors 710, carry out functions related to the operation of system 100. The controller 110 may be provided with one or more interfaces 770 for interfacing with, receiving data/commands from, sending data/commands to, and/or exchanging power and/or electrical energy with, components of the system 100, including but not limited to the deformable sensor 1, the one or more sensors 40, the agitator 30, the emitter 47, the microphone 45, and/or the interfaces 50.

The system 100 may also include a pressurized fluid source 120 for providing the working fluid to the deformable sensor 1. The pressurized fluid source 120 may be a tank 124 or container for holding a compressed fluid, such a compressed air tank. The pressurized fluid source 120 may be a compressor 122 or pump device configured to pressurize or otherwise convey the working fluid to the deformable sensor 1. The pressurized fluid source 120 may be any combination thereof. It is contemplated that the pressurized fluid source 120 may be provided with valves, motors, servos, regulators, power source, connectors, hoses, and the like, without limitation, to facilitate operation of the pressurized fluid source 120 and/or connection with components, such as the deformable sensor 1, plenums 70, or intermediate regulators, manifolds, distributors, or the like. The pressurized fluid source 120 and/or any motors, valves, control devices, or the like may be connected to and/or otherwise controlled by the controller 110. The controller 110 may be configured to provide control signals to the pressurized fluid source 120 or may additionally/alternatively provide energy or electrical power to operate the pressurized fluid source 120.

For example, the controller 110 may operate the pressurized fluid source 120 – opening/closing valves, increasing/decreasing the speed of a compressor 122, and the like – to increase the flow of working fluid to a deformable sensor 1, increasing the liquefaction effect of the granular medium 20 therein, and thereby softening the touch and/or increasing the malleability of the deformable membrane 10 of the deformable sensor 1. In another example, the controller 110 may operate the pressurized fluid source 120 – opening/closing valves, increasing/decreasing the speed of a compressor 122, and the like – to decrease the flow of working fluid to a deformable sensor 1, decreasing the liquefaction effect of granular medium 20 therein, and thereby hardening the touch and/or decreasing the malleability of the deformable membrane 10 of the deformable sensor 1. In yet another example, the controller 110 may increase or decrease the vibration intensity of vibrator 34 disposed in or on a deformable sensor 1, likewise increasing or decreasing, respectively, the liquefaction effect of the granular medium 20 therein, and influencing the touch/malleability of the deformable sensor 1.

Similarly, the controller 110 may influence the duty cycle, amplitude, frequency, and/or patterning of these control inputs to the pressurized fluid source 120 and/or the vibrator 34 to further influence the touch/malleability of an attached deformable sensor 1.

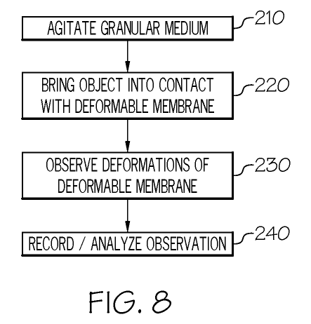

Referring now to FIG. 8, an exemplary method for operating a deformable sensor according to any of the embodiments disclosed herein is shown. Consistent with those descriptions above, a deformable sensor may be provided.

In step 210, one or more agitators 30 are activated, such as by flowing the working fluid through an aerator 32 and/or by supplying power and/or control signals to a vibrator 34, to agitate the granular medium 20 contained within the deformable sensor 1. Activation of the agitators thereby fluidizes the granular medium 20, making the granular medium 20 and, by extension, the deformable membrane 10, more malleable.

In step 220, the deformable sensor 1 is brought into contact with an object, or an object is brought into contact with the deformable sensor 1.

In step 230, the one or more sensors 40 are used to observe the deformations caused in the deformable membrane 10 by the object.

In step 240, observations of the sensors 40 are recorded and processed by the controller 110 to determine parameters such as the shape and/or geometry of the object, the orientation and/or pose of the object, the gripping force being applied to the object, and the like.

It should now be understood that embodiments of the present disclosure are directed to systems and methods for operating deformable sensors with granular solid mediums.

It is noted that recitations herein of a component of the present disclosure being “configured” or “programmed” in a particular way, to embody a particular property, or to function in a particular manner, are structural recitations, as opposed to recitations of intended use. More specifically, the references herein to the manner in which a component is “configured” or “programmed” denotes an existing physical condition of the component and, as such, is to be taken as a definite recitation of the structural characteristics of the component.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

It is noted that the terms “substantially” and “about” and “approximately” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

1. A deformable sensor, comprising:
an enclosure comprising a housing and a deformable membrane coupled to the housing,
a granular medium disposed within the enclosure, and
an agitator, wherein the agitator is configured to stimulate and thereby fluidize the granular medium.

2. The deformable sensor of claim 1, wherein the agitator comprises at least one inlet to the enclosure for injecting a flow of a working fluid into the enclosure.

3. The deformable sensor of claim 2, wherein the agitator further comprises an aerator for diffusing the working fluid into the enclosure.

4. The deformable sensor of claim 2, wherein the deformable membrane is at least partially provided with a plurality of perforations which are sized to permit the working fluid to exit the enclosure.

5. The deformable sensor of claim 4, wherein the plurality of perforations are sized to prevent the granular medium from exiting the enclosure.

6. The deformable sensor of claim 1, wherein the agitator is a vibrator.

7. The deformable sensor of claim 1, further comprising at least one sensor which observes at least a portion of the deformable membrane.

8. The deformable sensor of claim 7, further comprising at least one emitter which is operable with the at least one sensor.

9. The deformable sensor of claim 1, wherein adjusting a stimulus provided by the agitator influences a degree to which the granular medium is fluidized.

10. The deformable sensor of claim 1, further comprising a microphone.

11. A system for sensing objects using a deformable sensor, comprising:
at least one deformable sensor comprising:
an enclosure comprising a housing and a deformable membrane coupled to the housing, and
a granular medium disposed within the enclosure;
an agitator, wherein the agitator is configured to stimulate and thereby fluidize the granular medium; and
a controller communicatively coupled to the at least one deformable sensor and the agitator, the controller configured to control operation of the agitator.

12. The system of claim 11, further comprising a pressurized fluid source, and
wherein the pressurized fluid source feeds the agitator with a working fluid.

13. The system of claim 12, wherein the deformable membrane of each of the at least one deformable sensor is at least partially provided with a plurality of perforations which are sized to permit the working fluid to exit the enclosure.

14. The system of claim 13, wherein the plurality of perforations are sized to prevent the granular medium from exiting the enclosure.

15. The system of claim 11, wherein the agitator is a vibrator.

16. The system of claim 11, further comprising at least one sensor which observes at least a portion of the deformable membrane.

17. A method for sensing an object using a deformable sensor, the method comprising:
agitating a granular medium provided in an enclosure of the deformable sensor to fluidize the granular medium, and
bringing the object into contact with a deformable membrane of the deformable sensor, the deformable membrane at least partially defining the enclosure.

18. The method of claim 17, further comprising observing, with at least one sensor, deformations of the deformable membrane caused by the object.

19. The method of claim 17, further comprising pumping a working fluid into the enclosure to fluidize the granular medium.

20. The method of claim 19, wherein the deformable membrane is provided with a plurality of perforations, and the plurality of perforations are sized to permit the working fluid to exit the enclosure and to restrict the granular medium from exiting the enclosure.
